(19) United States
(12) Patent Application Publication
(10) Pub. No.: US 2015/0228413 A1
(43) Pub. Date: Aug. 13, 2015

(54) SOLID ELECTROLYTIC CAPACITOR, METHOD OF MANUFACTURING THE SAME, AND CHIP-TYPE ELECTRONIC COMPONENT

(71) Applicant: SAMSUNG ELECTRO-MECHANICS CO., LTD., Suwon-Si (KR)

(72) Inventors: Hee Sung CHOI, Suwon-Si (KR); Kyoung Hwan KIM, Suwon-Si (KR)

(73) Assignee: SAMSUNG ELECTRO-MECHANICS CO., LTD., Suwon-Si (KR)

(21) Appl. No.: 14/267,196

(22) Filed: May 1, 2014

(30) Foreign Application Priority Data
Feb. 13, 2014 (KR) 10-2014-0016709

(51) Int. Cl. H01G 9/052; H01G 9/042; H01G 9/00; H01G 9/15

(52) U.S. Cl. CPC H01G 9/052; H01G 9/15; H01G 9/042; H01G 9/0032; H01G 9/0036

(57) ABSTRACT

A solid electrolytic capacitor may include: an anode body formed of a porous sintered material containing a tantalum powder having an average particle size of 100 nm or less; an anode wire having a portion buried in the porous sintered material in a length direction; a dielectric layer formed on a surface of the porous sintered material; and a solid electrolytic layer disposed on a surface of the dielectric layer. When a cross-sectional area of the anode wire in a thickness-width direction is defined as A1 and a cross-sectional area of the anode body in the thickness-width direction is defined as A2, 0.05≦A1/A2≦0.5 is satisfied.

### CROSS-REFERENCE TO RELATED APPLICATION

This application claims the benefit of Korean Patent Application No. 10-2014-0016709 filed on Feb. 13, 2014, with the Korean Intellectual Property Office, the disclosure of which is incorporated herein by reference.

### BACKGROUND

The present disclosure relates to a solid electrolytic capacitor, a method of manufacturing the same, and a chip-type electronic component.

Tantalum (Ta) is a metal that has been widely used in the whole industrial field including aerospace and military fields and the like, as well as electrical, electronic, mechanical, and chemical engineering fields, due to excellent mechanical or physical characteristics such as a high melting point, softness, excellent corrosion resistance, and the like.

Such a tantalum material has been widely used as an anode material of a small capacitor since it is capable of forming a stable anodic oxidation film. Recently, in accordance with rapid development of an information technology (IT) industry such as electronics and information and Communications, the amount of use of tantalum has rapidly increased.

Generally, a capacitor may refer to a condenser temporally storing electricity therein, may be a component in which two flat plate electrodes insulated from each other are disposed to be adjacent to each other, a dielectric material is inserted between the two flat plate electrodes, and electric charges are charged and accumulated by attractive force, and may be used in order to obtain a capacitance by confining electric charges and electric fields in a space enclosed by two conductors.

A tantalum capacitor using such a tantalum material, which uses an empty gap occurring when a tantalum powder is sintered and then hardened, may be manufactured by forming a tantalum oxide (Ta₂O₅) on a tantalum surface by an anodizing method, forming a manganese dioxide (MnO₂) layer, which is an electrolyte, on the tantalum oxide using the tantalum oxide as a dielectric material, forming a carbon layer and a metal layer on the manganese dioxide layer to form a body, forming an anode and a cathode on the body so as to be mounted on a circuit board, and forming a molding part.

### RELATED ART DOCUMENT

### (Patent Document 1) Japanese Patent Laid-Open Publication No. 2009-094478

### SUMMARY

An aspect of the present disclosure may provide a solid electrolytic capacitor, a method of manufacturing the same, and a chip-type electronic component.

According to an aspect of the present disclosure, a solid electrolytic capacitor may include: an anode body including a porous sintered material containing a tantalum powder having an average particle size of 100 nm or less; an anode wire having a portion buried in the porous sintered material in a length direction; a dielectric layer disposed on a surface of the porous sintered material; and a solid electrolytic layer disposed on a surface of the dielectric layer, wherein when a cross-sectional area of the anode wire in a thickness-width direction is defined as A1 and a cross-sectional area of the anode body in the thickness-width direction is defined as A2, 0.05≦A1/A2≦0 0.5 is satisfied.

When a thickness of the anode wire is defined as T1 and a thickness of the anode body is defined as T2, 0.2≦T1/T2≦0.7 may be satisfied.

When a length of the portion of the anode wire buried in the anode body is defined as L1 and a length of the anode body is defined as L2, 0.5≦L1/L2≦0.9 may be satisfied.

When a surface area of the dielectric layer is defined as S1 and an area of a region in which the solid electrolytic layer is formed on the surface of the dielectric layer is defined as S2, 0.7≦S2/S1≦0.9 may be satisfied.

The solid electrolytic capacitor may have a filling ratio of 70% or more to 90% or less.

The solid electrolytic capacitor may have a filling ratio of 80% or more.

The dielectric layer may be formed by oxidizing a surface of the anode body.

The solid electrolytic layer may contain one or more of a conductive polymer and a manganese dioxide.

According to another aspect of the present disclosure, a solid electrolytic capacitor may include: an anode body including a porous sintered material containing a tantalum powder having an average particle size of 100 nm or less; and an anode wire having a portion buried in the anode body in a length direction; wherein when an area of a region enclosed by an edge of the anode wire and an area of a region enclosed by an edge of the anode body in a cross-section of the anode body in a thickness-width direction including the anode wire partially buried therein are defined as A1 and A2, respectively, 0.05≦A1/A2≦0.5 is satisfied.

According to another aspect of the present disclosure, a method of manufacturing a solid electrolytic capacitor, may include: preparing an anode wire; forming an anode body by sintering a forming body containing a tantalum powder having an average particle size of 100 nm or less and formed to have a portion of the anode wire buried therein; forming a dielectric layer by oxidizing a surface of the anode body; and forming a solid electrolytic layer on a surface of the dielectric layer, wherein when a cross-sectional area of the anode wire in a thickness-width direction is defined as A1 and a cross-sectional area of the anode body in the thickness-width direction is defined as A2, 0.05≦A1/A2≦0.5 is satisfied.

When a thickness of the anode wire is defined as T1 and a thickness of the anode body is defined as T2, 0.2≦T1/T2≦0.7 may be satisfied.

When a length of the portion of the anode wire buried in the anode body is defined as L1 and a length of the anode body is defined as L2, 0.5≦L1/L2≦0.9 may be satisfied.

When a surface area of the dielectric layer is defined as S1 and an area of a region in which the solid electrolytic layer is formed on the surface of the dielectric layer is defined as S2, 0.7≦S2/S1≦0.9 may be satisfied.

According to another aspect of the present disclosure, a chip-type electronic component may include: a capacitor part including an anode body including a porous sintered material containing a tantalum powder having an average particle size of 100 nm or less, an anode wire having a portion buried in the porous sintered material in a length direction, a dielectric layer disposed on a surface of the porous sintered material, a solid electrolytic layer disposed on a surface of the dielectric layer, and a cathode layer disposed on a surface of the solid electrolytic layer and connected to a cathode lead portion; a molding part enclosing the capacitor part; an anode lead portion connected to the anode wire and led outwardly of the molding part; and the cathode lead portion connected to the cathode layer and led outwardly of the molding part, when a cross-sectional area of the anode wire in a thickness-width direction is defined as A1 and a cross-sectional area of the anode body in the thickness-width direction is defined as A2, 0.05≦A1/A2≦0.5 is satisfied.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a perspective view schematically showing a solid electrolytic capacitor according to an exemplary embodiment of the present disclosure;

FIG. 2 is a cross-sectional view taken along line A-A′ of FIG. 1;

FIG. 3 is a schematic cross-sectional view of components taken along line A-A′ of FIG. 1 in order to explain a dimension relationship of the solid electrolytic capacitor according to an exemplary embodiment of the present disclosure;

FIG. 4 is a schematic cross-sectional view of components taken along line B-B′ of FIG. 1 in order to explain the dimension relationship of the solid electrolytic capacitor according to an exemplary embodiment of the present disclosure;

FIG. 5 is a flow chart showing a method of manufacturing a solid electrolytic capacitor according to an exemplary embodiment of the present disclosure;

FIG. 6 is a perspective view of a chip-type electronic component according to another exemplary embodiment of the present disclosure; and

FIG. 7 is a cross-sectional view taken along line C-C′ of FIG. 6.

### DETAILED DESCRIPTION

Exemplary embodiments of the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

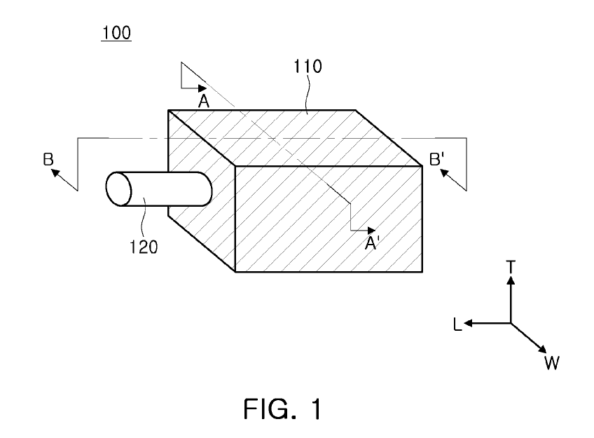

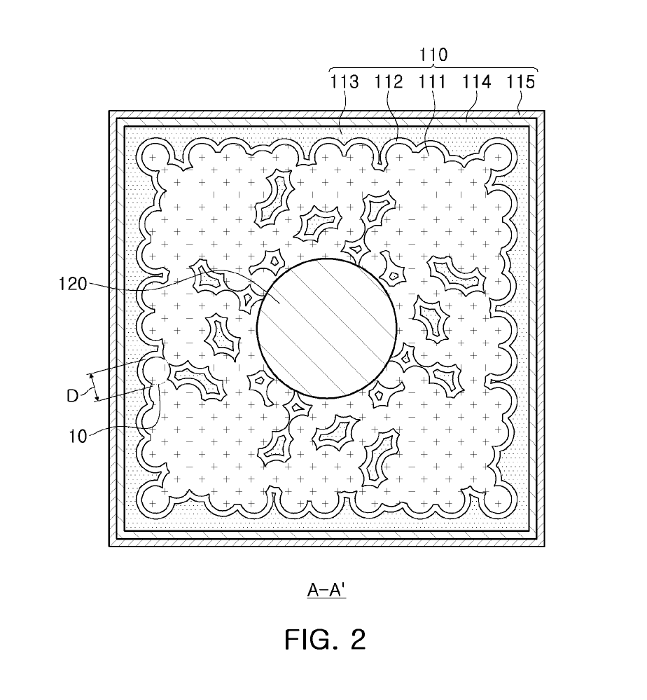

FIG. 1 is a perspective view schematically showing a solid electrolytic capacitor according to an exemplary embodiment of the present disclosure. FIG. 2 is a cross-sectional view taken along line A-A′ of FIG. 1.

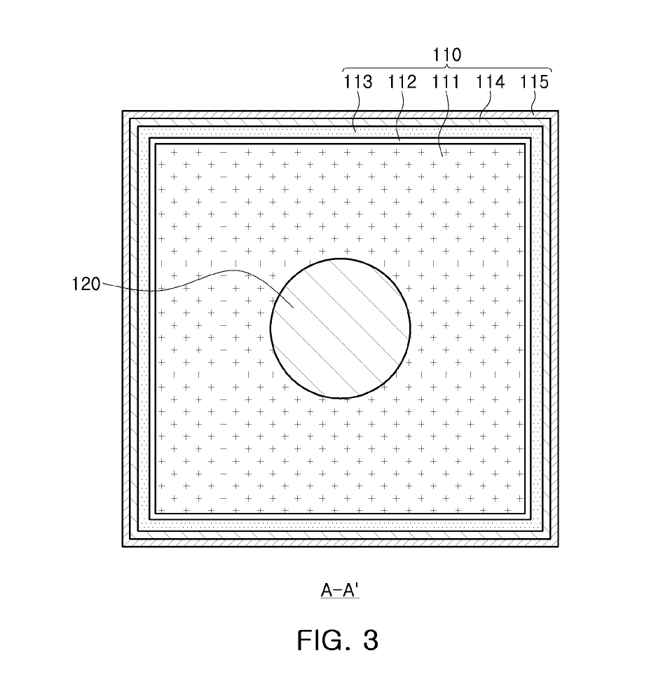

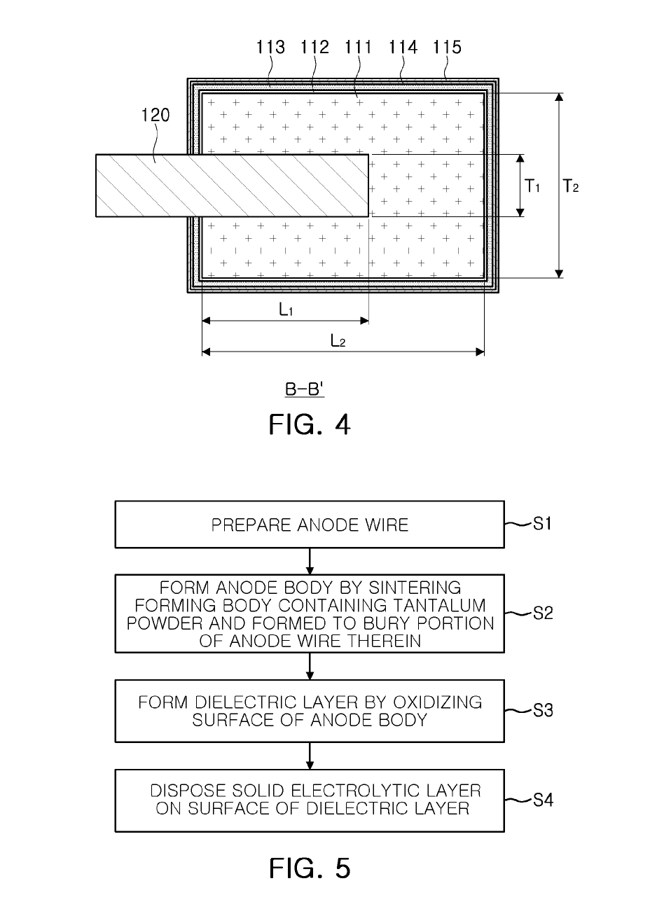

FIG. 3 is a schematic cross-sectional view of components taken along line A-A′ of FIG. 1 in order to explain a dimension relationship of the solid electrolytic capacitor according to an exemplary embodiment of the present disclosure. FIG. 4 is a schematic cross-sectional view of components taken along line B-B′ of FIG. 1 in order to explain the dimension relationship of the solid electrolytic capacitor according to an exemplary embodiment of the present disclosure.

Referring to FIGS. 1 and 2, a solid electrolytic capacitor 100 according to the exemplary embodiment may include an anode wire 120 and a capacitor body 110, and the capacitor body 110 may include an anode body 111; a dielectric layer 112; and a solid electrolytic layer 113.

According to an exemplary embodiment of the present disclosure, the capacitor body may further include cathode layers 114 and 115.

Further, in the exemplary embodiment, it is noted to be understood that a forward direction refers to a direction in which the anode wire 120 is exposed in the anode body 111, a rearward direction refers to a direction opposite to the forward direction, a length L direction refers to a direction that is in parallel with the forward and rearward directions, a thickness T direction refers to a direction perpendicular to the length direction, a width W direction refers to a direction perpendicular to the length direction and the thickness direction, a front surface refers to a surface on which the anode wire 120 is led in surfaces of the anode body 111 facing each other in the length direction, a rear surface refers to a surface facing the front surface, an upper surface and a lower surface refer to both surfaces of the anode body 111 facing each other in the thickness direction, respectively, and both side surfaces refer to both surfaces of the anode body 111 facing each other in the width direction, respectively.

The anode body 111 may be formed of tantalum, and may be formed of a porous sintered material containing a tantalum powder 10, as shown in FIG. 2. As an example, the anode body 111 may be manufactured by mixing and agitating a tantalum powder and a binder with each other in a predetermined ratio, compressing the powder mixture to form the powder mixture in a rectangular parallelepiped shape and then, sintering the powder mixture in the rectangular parallelepiped shape at a high temperature and under high vibration conditions.

In addition, the anode wire 120 may be formed of a tantalum metal and may be in the form of a pillar having a circular cross-section or a polygonal cross-section. For example, a cross-section of the anode wire may have a circular shape, as shown in FIG. 2. Although not shown, the cross-section of the anode wire may have a square shape or a rectangular shape.

The anode body 111 may have a portion of the anode wire 120 buried therein in the length direction in such a manner that the anode wire 120 is partially exposed in the forward direction.

For example, before the mixture of the tantalum powder and the binder is compressed to form the anode body 111, the anode wire 120 may be inserted into the mixture of the tantalum powder and the binder such that a portion thereof may be buried in a central region of the mixture.

For example, the anode body 111 may be manufactured by inserting the anode wire 120 into the tantalum powder with which the binder is mixed to form a tantalum element having a desired size and subsequently, sintering the tantalum element under a high vacuum atmosphere (10⁻⁵ torr or less) at a temperature of about 1000 to 2000° C. for about 30 minutes.

The anode body 111 may have the dielectric layer 112 formed on a surface thereof. The dielectric layer 112 may be formed by oxidizing the surface of the anode body 111. For example, the dielectric layer 112 may be formed of a dielectric material containing a tantalum oxide (Ta₂O₅), which is an oxide of tantalum forming the anode body, and may be formed at a predetermined thickness on the surface of the anode body 111.

In order to form a cathode, the solid electrolytic layer 113 may be formed on a surface of the dielectric layer. The solid electrolytic layer 113 may contain one or more of a conductive polymer and a manganese dioxide (MnO₂).

In a case in which the solid electrolytic layer 113 is formed of the conductive polymer, it may be formed on the surface of the dielectric layer 112 by a chemical polymerization method or an electrolytic polymerization method. The conductive polymer material is not particularly limited as long as it is a polymer material having conductivity, and examples thereof may include, for example, polypyrole, polythiophene, polyaniline, and the like.

In a case in which the solid electrolytic layer 113 is formed of the manganese dioxide (MnO₂), the anode body having the dielectric layer formed on the surface thereof may be immersed in an aqueous manganese solution such as nitric acid manganese, and subsequently, the aqueous manganese solution may be decomposed by applying heat thereto to form a conductive manganese dioxide on the surface of the dielectric layer.

The cathode layers 114 and 115 may be configured of a laminated film including a carbon layer 114 containing carbon and a silver layer 115 containing silver (Ag) particles and may be disposed on a surface of the solid electrolytic layer 113.

The carbon layer 114 may be formed of a carbon paste and may be formed by applying the carbon paste dispersed in water or an organic solvent in a state in which a conductive carbon material powder such as natural graphite, carbon black, or the like, is mixed with a binder, a dispersing agent, or the like, onto the solid electrolytic layer 113.

The sliver (Ag) layer 115 may be formed of a silver paste containing silver particles and may be formed by applying the silver pastes onto the carbon layer 114.

The carbon layer 114 may be provided to decrease surface contact resistance, and the silver (Ag) layer 115 may be provided to improve electrical conductivity to a cathode lead.

According to an exemplary embodiment of the present disclosure, as shown in FIG. 2, the anode body may be formed of a porous sintered material containing the tantalum powder 10 having an average particle size of 100 nm or less.

According to an exemplary embodiment of the present disclosure, the tantalum powder 10 having the average particle size of 100 nm and a high coefficient of variation (CV) may be used to implement a high capacitance. This may be due to an increase in a surface area depending on the use of the tantalum powder having the high CV.

Next, a dimension relationship between the anode wire 120 and the anode body 111 of the solid electrolytic capacitor according to an exemplary embodiment of the present disclosure will be described in detail with reference to FIGS. 3 and 4.

FIG. 3 is a cross-sectional view schematically showing the anode wire 120, the anode body 111, the dielectric layer 112, the solid electrolytic layer 113, and the cathode layers 114 and 115 in a cross-section taken along line A-A′ of FIG. 1; and FIG. 4 is a cross-sectional view schematically showing the anode wire 120, the anode body 111, the dielectric layer 112, the solid electrolytic layer 113, and the cathode layers 114 and 115 in the cross-section taken along line B-B′ of FIG. 1.

FIG. 3 schematically shows a cross-section of the solid electrolytic capacitor according to an exemplary embodiment of the present disclosure in a thickness-width direction. According to an exemplary embodiment of the present disclosure, as shown in FIG. 3, when a cross-sectional area of the anode wire 120 in the thickness-width direction is defined as A1 and a cross-sectional area of the anode body 111 in the thickness-width direction is defined as A2, the following Equation may be satisfied: 0.05≦A1/A2≦0.5.

In the present specification, in a case in which the cross-section of the anode body in the thickness-width direction is a cross-section thereof in the thickness-width direction including the anode wire partially buried therein, the cross-sectional area of the anode body in the thickness-width direction may be defined as an area including the area of the anode wire.

In other words, when an area of a region enclosed by an edge of the anode wire and an area of a region enclosed by an edge of the anode body in a cross-section A-A′ of the capacitor body 110 in the thickness-width direction in the state in which the anode wire 120 is buried in the anode body 111 are defined as A1 and A2, respectively, a ratio of the area of the region enclosed by the edge of the anode wire to the area of the region enclosed by the edge of the anode body may satisfy 0.05≦A1/A2≦0.5.

In the present specification, A2 denoting the cross-section of the anode body 111 in the thickness-width direction may be based on an overall shape of the anode body, as shown in FIG. 3.

According to an exemplary embodiment of the present disclosure, in a case in which the anode body 111 is formed by sintering the tantalum powder having the average particle size of 100 nm or less, the above Equation may be satisfied: 0.05≦A1/A2≦0.5.

In a case in which A1/A2 is less than 0.05, a filling ratio may be decreased, and in a case in which A1/A2 exceeds 0.5, a crack may occur in the anode body, and strength of the anode body may be decreased, such that LC quality may be deteriorated. In a case in which A1/A2 exceeds 0.5, the crack may occur in the anode body due to a difference in expansion and contraction rates between the anode wire and the anode body, which has an influence on quality of the dielectric material to deteriorate dielectric characteristics.

Further, a filling ratio of the solid electrolytic capacitor according to an exemplary embodiment of the present disclosure may be 70% or more to 90% or less.

The filling ratio may be defined as a ratio of an area of a region in which the solid electrolytic layer 113 is formed to a surface area of the dielectric layer 112.

In other words, when a surface area of the dielectric layer 112 is defined as S1 and an area of a region in which the solid electrolytic layer 113 is formed on a surface of the dielectric layer is defined as S2, the following Equation may be satisfied: 0.7≦S2/S1≦0.9.

The surface area of the dielectric layer refers to an area of an outer surface of the dielectric layer opposing to an inner surface of the dielectric layer adjacent to the anode body.

That is, a ratio of an area of a region covered by the solid electrolytic layer to the area of the outer surface of the dielectric layer may be 70% or more to 90% or less.

The filling ratio may be measured by the following method. First, a capacitance of a finished product of the solid electrolytic capacitor of which a capacitance is to be measured may be measured. Here, the finished product may be in a state in which the anode wire, the anode body, the dielectric layer, the solid electrolytic layer, and the cathode layers are formed. Next, an element (hereinafter, referred to as a capacitance element) in which only the anode wire, the anode body, and the dielectric layer remain may be prepared by removing the cathode layers and the solid electrolytic layer from the finished product of which the capacitance is measured. The solid electrolytic layer may be removed using a mixed solution containing nitric acid and hydrogen peroxide, and the mixed solution containing the nitric acid and the hydrogen peroxide may be heated in order to decrease a time required for removing the solid electrolytic layer.

Next, the capacitance element may be immersed in 3 to 30 wt % of a nitric acid aqueous solution or a sulfuric acid aqueous solution so that the dielectric layer is submerged therein, and a capacitance (ideal capacitance) may be measured. A percentage ratio of the capacitance of the finished product to the ideal capacitance may be defined as the filling ratio. In other words, when the capacitance of the finished product is C1 and the ideal capacitance is C2, the filling ratio may be defined as (C1/C2)×100.

According to an exemplary embodiment of the present disclosure, even in a case in which the anode body is formed of the tantalum powder having the average particle size of 100 nm or less, the solid electrolytic capacitor having an excellent filling ratio of 70% or more may be manufactured. In a case in which the filling ratio is less than 70%, it may be difficult to implement a capacitance. In addition, the filling ratio may be 90% or less. In a case in which the filling ratio exceeds 90%, a crack may occur in the anode body.

More preferably, the filling ratio may be 80% or more.

According to an exemplary embodiment of the present disclosure, in a case in which the anode body is formed by sintering the tantalum powder having the average particle size of 100 nm or less, when a thickness of the anode wire 120 is defined as T1 and a thickness of the anode body 111 is defined as T2, the following Equation may be satisfied: 0.2≦T1/T2≦0.7.

In a case in which T1/T2 is less than 0.2, the filling ratio may be decreased, and in a case in which T1/T2 exceeds 0.7, the crack may occur in the anode body or strength of the anode body may be decreased, and LC quality may be deteriorated.

In addition, according to an exemplary embodiment of the present disclosure, in a case in which the anode body is formed by sintering the tantalum powder having the average particle size of 100 nm or less, when a length of a portion of the anode wire 120 buried in the anode body 111 is defined as L1 and a length of the anode body 111 is defined as L2, the following Equation may be satisfied: 0.5≦L1/L2≦0.9. In a case in which L1/L2 is less than 0.5, a contact area between the anode wire and the anode body may be decreased, such that an equivalent series resistance (ESR) may be increased, and in a case in which L1/L2 exceeds 0.9, the anode wire may be excessively inserted into the anode body, such that there may be a risk that the anode wire will be exposed and a capacitance decrease may occur.

According to an exemplary embodiment of the present disclosure, even in a case in which the anode body is formed of the tantalum powder having the average particle size of 100 nm or less, the solid electrolytic capacitor having an excellent capacitance implementation ratio, a low equivalent series resistance, and improved strength may be provided.

FIG. 5 is a flowchart showing a method of manufacturing a solid electrolytic capacitor according to an exemplary embodiment of the present disclosure.

As shown in FIG. 5, the method of manufacturing a solid electrolytic capacitor according to an exemplary embodiment of the present disclosure may include: preparing the anode wire (S1); forming the anode body by sintering a forming body containing the tantalum powder having the average particle size of 100 nm or less and formed to have a portion of the anode wire buried therein (S2); forming the dielectric layer by oxidizing a surface of the anode body (S3); and disposing the solid electrolytic layer on a surface of the dielectric layer (S4).

Since a description of the method of manufacturing a solid electrolytic capacitor according to the exemplary embodiment is overlapped with the description of the solid electrolytic capacitor according to the foregoing exemplary embodiment of the present disclosure, the description thereof will be omitted.

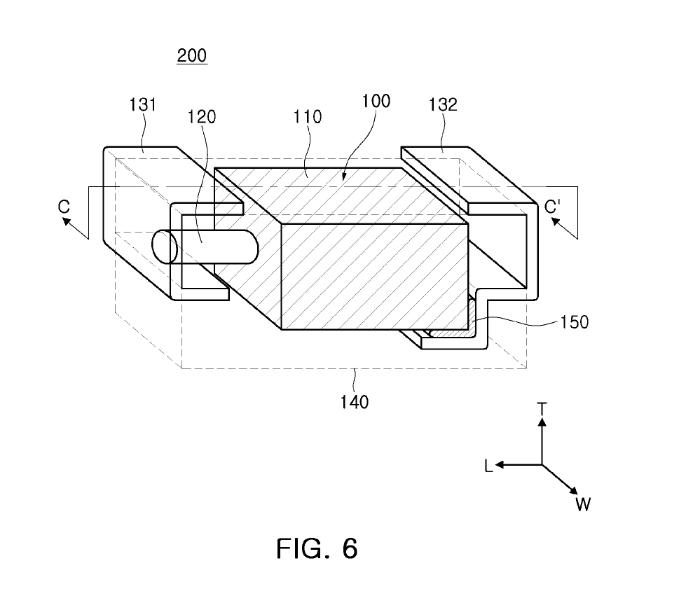

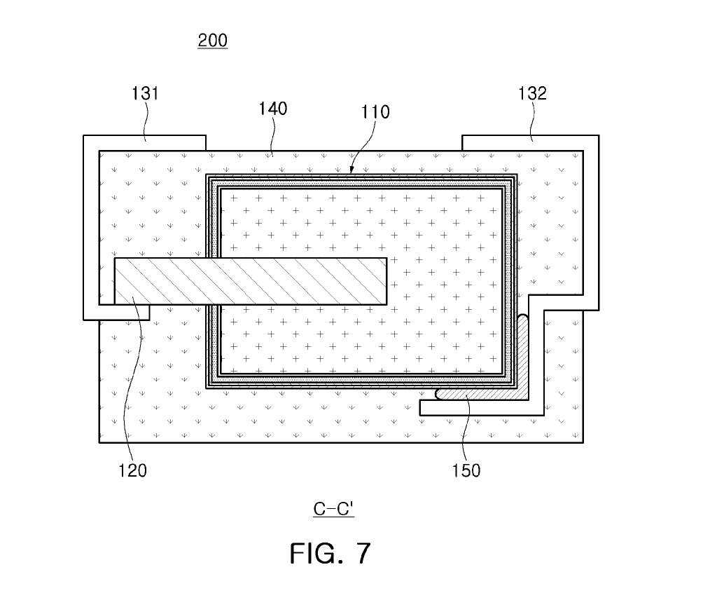

FIG. 6 is a perspective view of a chip-type electronic component according to another exemplary embodiment of the present disclosure; and FIG. 7 is a cross-sectional view taken along line C-C′ of FIG. 6.

Referring to FIG. 6, a chip-type electronic component 200 according to another exemplary embodiment of the present disclosure may include the solid electrolytic capacitor 100 as a capacitor part; a molding part 140 enclosing the capacitor part; and anode and cathode lead portions 131 and 132 connected to the capacitor part and led outwardly of the molding part.

Some of reference numerals overlapped with those of FIG. 4 among reference numerals of FIG. 6 will be omitted. In addition, see FIG. 4 with respect to a description for the solid electrolytic capacitor.

The capacitor part may include the anode body 111 formed of the porous sintered material containing the tantalum powder having the average particle size of 100 nm or less, the anode wire 120 having a portion in the length direction, buried in the porous sintered material and connected to the anode lead portion, the dielectric layer 112 formed on the surface of the porous sintered material, the solid electrolytic layer 113 disposed on the surface of the dielectric layer, and the cathode layers 114 and 115 disposed on the surface of the solid electrolytic layer and connected to the cathode lead portion.

The capacitor part may have the same configuration as that of the solid electrolytic capacitor according to an exemplary embodiment of the present disclosure described above. Therefore, hereinafter, an overlapped description will be omitted.

In order to electrically connect the solid electrolytic capacitor 100 enclosed by the molding part 140 to the outside, the anode lead portion 131 and the cathode lead portion 132 may be disposed to be connected to the solid electrolytic capacitor. The anode lead portion may include an anode connection portion and an anode terminal portion, and the cathode lead portion may include a cathode connection portion and a cathode terminal portion.

The anode connection portion may be electrically connected to a region of the anode wire exposed from the anode body, and the anode terminal portion may be led outwardly of the molding part to serve as a connection terminal receiving a voltage applied from the outside thereto or electrically connected to another electronic product. In addition, the cathode connection portion may be electrically connected to the cathode layer, and the cathode terminal portion may be led outwardly of the molding part to serve as a connection terminal receiving a voltage applied from the outside thereto or electrically connected to another electronic product.

The anode wire 120 and the anode connection portion may be electrically attached and connected to each other by performing spot welding or laser welding or applying a conductive adhesive in a state in which the anode wire is connected to the anode connection portion of the anode lead portion 131.

The cathode layers 114 and 115 and the cathode connection portion may be connected to each other by a conductive adhesive layer 150 formed of a conductive adhesive. The conductive adhesive may contain an epoxy based thermosetting resin and a conductive metal powder. A predetermined amount of conductive adhesive may be dispensed or dotted to form the conductive adhesive layer 150, thereby attaching the capacitor body 110 and the cathode connection portion of the cathode lead portion 132 to each other. Then, the conductive adhesive layer 150 may be hardened at a temperature of 150 to 170° C. for 40 to 60 minutes in a closed oven or under reflow hardening conditions to serve to allow the capacitor body 110 not to be moved at the time of molding a resin.

Here, as the conductive metal powder, silver (Ag) powder may be used. However, the present disclosure is not limited thereto.

The molding part 140 may be formed by transfer-molding a resin such as an epoxy molding compound (EMC), or the like, so as to enclose the solid electrolytic capacitor 100.

The molding part 140 may serve to protect the solid electrolytic capacitor from the outside.

Here, the molding part 140 may be formed so that the anode terminal portion of the anode lead portion and the cathode terminal portion of the cathode lead portion are exposed.

For example, a molding temperature may be about 170° C., and such a temperature and other conditions for EMC molding may be appropriately adjusted depending on a component and a shape of a used EMC.

After the EMC is molded, the EMC may be hardened at a temperature of about 160° C. for 30 to 60 minutes in a closed oven or under a reflow hardening condition, if necessary.

In this case, a molding process may be performed so that the anode terminal portion of the anode lead portion and the cathode terminal portion of the cathode lead portion are outwardly exposed.

As set forth above, according to exemplary embodiments of the present disclosure, a solid electrolytic capacitor having an excellent capacitance implementation ratio, a low equivalent series resistance, and improved strength, and a method of manufacturing the same, and a chip-type electronic component including the same may be provided.

While exemplary embodiments have been shown and described above, it will be apparent to those skilled in the art that modifications and variations could be made without departing from the spirit and scope of the present disclosure as defined by the appended claims.

What is claimed is:

1. A solid electrolytic capacitor comprising:
an anode body including a porous sintered material containing a tantalum powder having an average particle size of 100 nm or less;
an anode wire having a portion buried in the porous sintered material in a length direction;
a dielectric layer disposed on a surface of the porous sintered material; and
a solid electrolytic layer disposed on a surface of the dielectric layer,
wherein when a cross-sectional area of the anode wire in a thickness-width direction is defined as A1 and a cross-sectional area of the anode body in the thickness-width direction is defined as A2, 0.05≦A1/A2≦0.5 is satisfied.

2. The solid electrolytic capacitor of claim 1, wherein when a thickness of the anode wire is defined as T1 and a thickness of the anode body is defined as T2, 0.2≦T1/T2≦0.7 is satisfied.

3. The solid electrolytic capacitor of claim 1, wherein when a length of the portion of the anode wire buried in the anode body is defined as L1 and a length of the anode body is defined as L2, 0.5≦L1/L2≦0.9 is satisfied.

4. The solid electrolytic capacitor of claim 1, wherein when a surface area of the dielectric layer is defined as S1 and an area of a region in which the solid electrolytic layer is formed on the surface of the dielectric layer is defined as S2, 0.7≦S2/S1≦0.9 is satisfied.

5. The solid electrolytic capacitor of claim 1, wherein the solid electrolytic capacitor has a filling ratio of 70% or more to 90% or less.

6. The solid electrolytic capacitor of claim 1, wherein the solid electrolytic capacitor has a filling ratio of 80% or more.

7. The solid electrolytic capacitor of claim 1, wherein the dielectric layer is formed by oxidizing a surface of the anode body.

8. The solid electrolytic capacitor of claim 1, wherein the solid electrolytic layer contains one or more of a conductive polymer and a manganese dioxide.

9. A solid electrolytic capacitor comprising:
an anode body including a porous sintered material containing a tantalum powder having an average particle size of 100 nm or less; and
an anode wire having a portion buried in the anode body in a length direction;
wherein when an area of a region enclosed by an edge of the anode wire and an area of a region enclosed by an edge of the anode body in a cross-section of the anode body in a thickness-width direction including the anode wire partially buried therein are defined as A1 and A2, respectively, 0.05≦A1/A2≦0.5 is satisfied.

10. A method of manufacturing a solid electrolytic capacitor, comprising:
preparing an anode wire;
forming an anode body by sintering a forming body containing a tantalum powder having an average particle size of 100 nm or less and formed to have a portion of the anode wire buried therein;
forming a dielectric layer by oxidizing a surface of the anode body; and
forming a solid electrolytic layer on a surface of the dielectric layer,
wherein when a cross-sectional area of the anode wire in a thickness-width direction is defined as A1 and a cross-sectional area of the anode body in the thickness-width direction is defined as A2, 0.05≦A1/A2≦0.5 is satisfied.

11. The method of claim 10, wherein when a thickness of the anode wire is defined as T1 and a thickness of the anode body is defined as T2, 0.2≦T1/T2≦0.7 is satisfied.

12. The method of claim 10, wherein when a length of the portion of the anode wire buried in the anode body is defined as L1 and a length of the anode body is defined as L2, 0.5≦L1/L2≦0.9 is satisfied.

13. The method of claim 10, wherein when a surface area of the dielectric layer is defined as S1 and an area of a region in which the solid electrolytic layer is formed on the surface of the dielectric layer is defined as S2, 0.7≦S2/S1≦0.9 is satisfied.

14. A chip-type electronic component comprising:
a capacitor part including an anode body including a porous sintered material containing a tantalum powder having an average particle size of 100 nm or less, an anode wire having a portion buried in the porous sintered material in a length direction, a dielectric layer disposed on a surface of the porous sintered material, a solid electrolytic layer disposed on a surface of the dielectric layer, and a cathode layer disposed on a surface of the solid electrolytic layer and connected to a cathode lead portion;
a molding part enclosing the capacitor part;
an anode lead portion connected to the anode wire and led outwardly of the molding part; and
the cathode lead portion connected to the cathode layer and led outwardly of the molding part,
when a cross-sectional area of the anode wire in a thickness-width direction is defined as A1 and a cross-sectional area of the anode body in the thickness-width direction is defined as A2, 0.05≦A1/A2≦0.5 is satisfied.
